(19) United States
(12) Patent Application Publication
(10) Pub. No.: US 2024/0346560 A1
(43) Pub. Date: Oct. 17, 2024

(54) STORAGE BILLING SYSTEM AND STORAGE BILLING METHOD

(71) Applicant: Hitachi, Ltd., Tokyo (JP)

(72) Inventor: Yuya YAMAMOTO, Tokyo (JP)

(21) Appl. No.: 18/237,086

(22) Filed: Aug. 23, 2023

(30) Foreign Application Priority Data
Apr. 12, 2023 (JP) 2023-064899

(51) Int. Cl. G06Q 30/04; G06Q 50/06

(52) U.S. Cl. CPC G06Q 30/04; G06Q 50/06

(57) ABSTRACT

A storage billing system including a fee calculation section that determines a fee on the basis of an amount of storage usage according to a contract that is renewed when the storage is updated, a contract history check section that, when the fee for the usage of the storage is to be determined, determines whether the contract is renewed, a carbon dioxide emissions calculation section that, when the contract history check section determines that the contract is renewed, determines a difference between an amount of power usage by the storage before the update and an amount of power usage by the storage after the update, and calculates an amount of carbon dioxide emissions reduction, a fee adjustment section that determines the fee by reducing the fee determined by the fee calculation section according to the amount of carbon dioxide emissions reduction determined by the carbon dioxide emissions calculation section.

### CROSS-REFERENCE TO RELATED APPLICATION

The present application claims priority from Japanese application JP2023-064899, filed on Apr. 12, 2023, the content of which h is hereby incorporated by reference into this application.

### BACKGROUND OF THE INVENTION

### 1. Field of the Invention

The present invention relates to a storage billing system and a storage billing method.

### 2. Description of the Related Art

A method of billing based on a data read amount and a data storage amount is available as a storage billing method. For example, in a system handling big data collected by the Internet of things (IoT), it is necessary to bear the storage cost of data of uncertain value. The data storage amount increases cumulatively, and increases unless the data is deleted. Therefore, the data storage cost increases over time. In view of these circumstances, Patent Document 1 (referred to as JP-2020-155071-A below) regards read data as valuable data, handles the read data as a billing target to collect money, and reflects the amount of collected money in the data storage cost. That is, disclosed in Patent Document 1 is a method of determining the amount of money that subtracts the amount of collected money from the amount of money based on the data storage amount.

Disclosed in Patent Document 2 (referred to as JP-2004-21799-A below) is a storage service fee calculation method that acquires access frequency information indicating how frequently a server accesses a storage, and calculates a storage service fee for billing the server according to the acquired access frequency information.

### SUMMARY OF THE INVENTION

The method described in Patent Document 1 performs billing based on the data storage amount, determines a bill to be paid when stored data is read, and uses the determined bill as a source of funds to discount the bill according to the data storage amount. This method requests that users who frequently read data should bear the cost.

The method described in Patent Document 2 performs billing based on the frequency of storage access. This method requests that users who frequently access a storage involving a high operating cost should bear the cost.

The above two methods both request storage users to bear the cost. The present invention has been made to reduce the fee to be paid by the storage users by using, as the source of funds, carbon credit obtained by using the latest storage system exhibiting higher energy efficiency.

In order to address the above-described problems, according to an aspect of the present invention, there is provided a storage billing system for determining a fee for usage of a storage, the storage billing system including a fee calculation section that determines a fee on the basis of an amount of storage usage according to a contract that is renewed when the storage is updated, a contract history check section that, when the fee for the usage of the storage is to be determined, determines whether the contract is renewed, a carbon dioxide emissions calculation section that, when the contract history check section determines that the contract is renewed, determines a difference between an amount of power usage by the storage before the update and an amount of power usage by the storage after the update, and calculates an amount of carbon dioxide emissions reduction, a fee adjustment section that determines the fee by reducing the fee determined by the fee calculation section according to the amount of carbon dioxide emissions reduction determined by the carbon dioxide emissions calculation section, and an output section that outputs the fee determined by the fee adjustment section.

The present invention makes it possible to reduce the fee for storage usage by a user who has updated a storage device. Problems, configurations, and advantages other than those described above will become apparent from description for the following embodiment.

### BRIEF DESCRIPTION OF THE DRAWINGS

FIG. 1 is a diagram illustrating an overview of a system according to an embodiment of the present invention;

FIG. 2 is a diagram illustrating an example system configuration of a storage billing system according to the embodiment of the present invention;

FIG. 3 is a diagram illustrating user benefits provided by a contract renewal according to the embodiment of the present invention;

FIG. 4 is a flowchart illustrating an example of storage billing system processing according to the embodiment of the present invention;

FIG. 5 illustrates an example of a customer contract management table according to the embodiment of the present invention;

FIG. 6 illustrates an example of a storage specifications table according to the embodiment of the present invention;

FIG. 7 illustrates an example of a storage operation record (5-minute average) table according to the embodiment of the present invention;

FIG. 8 illustrates an example of a storage operation record (daily average) table according to the embodiment of the present invention;

FIG. 9 illustrates an example of a CO2 emissions amount table according to the embodiment of the present invention;

FIG. 10 illustrates an example of a carbon credit unit price table according to the embodiment of the present invention;

FIG. 11 illustrates an example of a capacity unit price change history table according to the embodiment of the present invention; and

FIG. 12 illustrates an example of an environment and result report according to the embodiment of the present invention.

### DESCRIPTION OF THE PREFERRED EMBODIMENT

An embodiment of the present invention will now be described with reference to the accompanying drawings. In the accompanying drawings depicting the embodiment, identical component elements are designated by the same name and reference numeral wherever possible to avoid redundant explanation.

The present invention is not limited to the embodiment described below and extends to various modifications and equivalent configurations that fall within the spirit and scope of the appended claims. For example, the embodiment is described below in detail to facilitate the understanding of the present invention. The present invention is not necessarily limited to the embodiment including all the component elements described below.

Further, processing sections described in conjunction with the embodiment may be partly or wholly implemented in the form of hardware by designing them as integrated circuits or in the form of software by allowing a processor to interpret and execute programs implementing their functions.

For example, tables, regions, and the like described in conjunction with the embodiment may be database (DB) objects or may be data objects stored in a main memory.

### First Embodiment

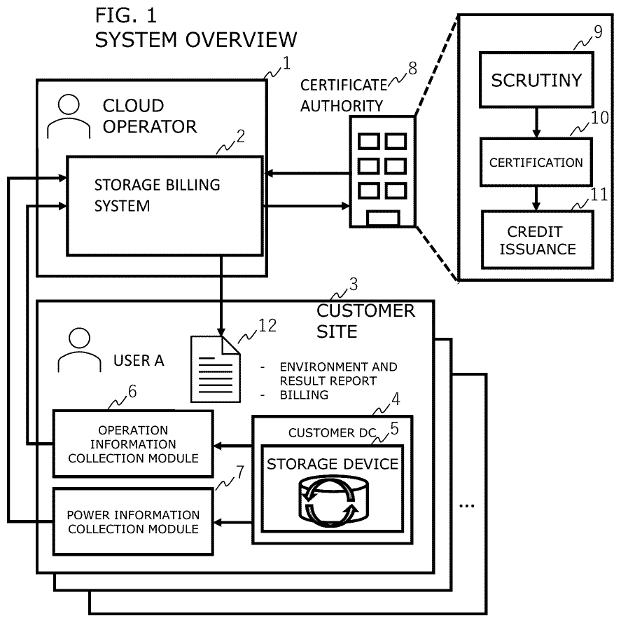

FIG. 1 is a diagram illustrating an overview of a system according to the embodiment of the present invention. A storage billing system 2 managed by a cloud operator 1 receives operation information regarding a storage device 5 at a customer site 3 from an operation information collection module 6, and receives power consumption information regarding the storage device 5 from a power information collection module 7.

The storage billing system 2 determines the amount of carbon dioxide (CO2) emissions reduction from the received power consumption information, transmits the amount of CO2 emissions reduction to a certificate authority 8, and submits an application for credit such as carbon credit. The certificate authority 8 scrutinizes the received application. If there is no problem with the received application, the certificate authority 8 authenticates the received application and issues credit to the cloud operator 1.

The cloud operator 1 performs billing in such a manner as to discount a fee for storage usage by using the amount of credit received from the certificate authority 8 as a source of funds and to charge the discounted fee to a user at the customer site. The fee for storage usage is described in an environment and result report 12 that is to be sent to the user. The amount of CO2 emissions reduction by a storage device update is additionally described in the environment and result report 12.

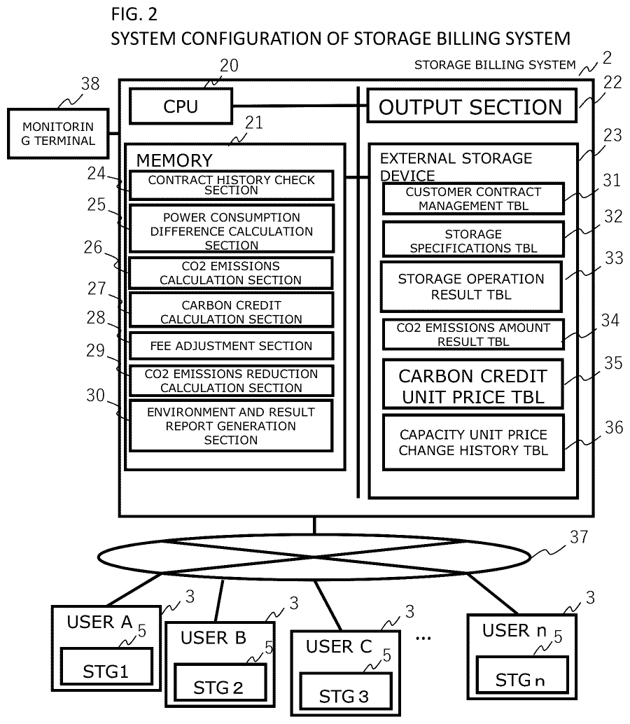

FIG. 2 is a diagram illustrating an example system configuration of the storage billing system 2 according to the embodiment of the present invention. The storage billing system 2 is connected to the storage device 5 at the customer site 3 through a network 37. Further, the storage billing system 2 is connected to a monitoring terminal 38 so as to allow the operating personnel of the cloud operator 1 to reference various types of information.

The storage billing system 2 which is formed by a computer includes a central processing unit (CPU) 20, a memory 21, an external storage device 23, and an output section 22. Software modules such as a contract history check section 24, a power consumption difference calculation section 25, a CO2 emissions calculation section 26, a carbon credit calculation section 27, a fee adjustment section 28, a CO2 emissions reduction calculation section 29, and an environment and result report generation section 30 are stored in the memory 21 and executed by the CPU 20.

The external storage device 23 stores tables such as a customer contract management table (TBL) 31, a storage specifications table (TBL) 32, a storage operation result table (TBL) 33, a CO2 emissions amount table result (TBL) 34, a carbon credit unit price table (TBL) 35, and a capacity unit price change history table (TBL) 36. These tables are referenced and updated by the software modules stored in the memory 21.

The output section 22 includes, for example, a network interface, and performs a process of receiving information regarding the storage device 5 at the customer site 3 and sending the environment and result report to the user at the customer site 3.

The present embodiment is described with reference to an example in which the storage billing system 2 is implemented by a standalone server. However, the storage billing system 2 may alternatively be implemented by a cloud system or implemented by dividing functionality into a plurality of computers.

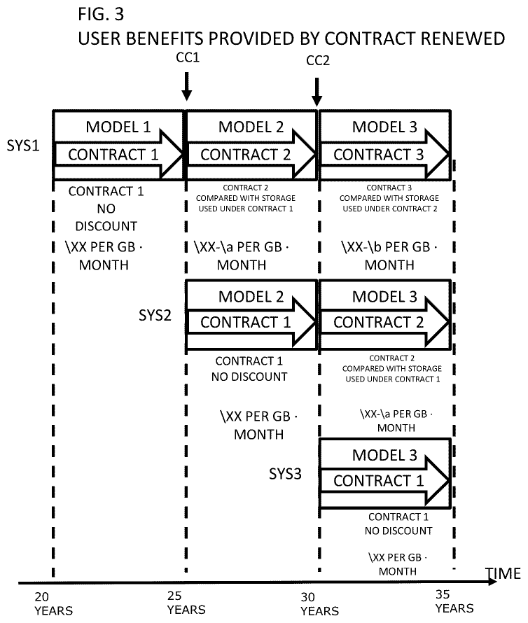

FIG. 3 is a diagram illustrating user benefits provided by a contract renewal according to the embodiment of the present invention. In recent years, global warming due to carbon dioxide emissions has become a threat. However, in the case of storage use, too, problems caused by carbon dioxide emissions are unavoidable. Year after year, high-performance storage devices yielding a reduced amount of carbon dioxide emissions are commercialized due to advances in technology. However, a currently used storage device is not always timely updated to the latest storage device.

Work and time for data migration and testing are required to update the storage devices. Therefore, updating the storage devices may adversely affect the work of users of the storage devices.

Accordingly, the update of a storage device may possibly be promoted when the fee for storage device usage is discounted by using, as the source of funds, redeemable credit, such as carbon credit derived from CO2 emissions reducible by a storage device update.

In the example of FIG. 3, the fee for storage device usage is not discounted for a user of SYS1 under contract 1 in which model 1 of a storage device is used. However, the fee discounted by ¥a per GB·month is applied to the user by using, as the source of funds, carbon credit CC1 that is obtained when contract 2 is newly signed with the storage device updated to model 2.

When contract 3 is newly signed with the storage device updated from model 2 to model 3, the fee discounted by ¥b per GB-month is applied to the user by using obtained carbon credit CC2 as the source of funds.

Meanwhile, the fee discounted by ¥a per GB or ¥b per GB is not applied to a user of SYS2 who uses model 2 of the storage device or a user of SYS3 who uses model 3 of the storage device because these users do not update the storage device.

The above example is described with reference to carbon credit. However, the above example is also applicable to the use of any other credit usable as the source of funds. Further, in a case where the credit can be received every month, a discounted fee may be applied every month. Moreover, in a case where the credit can be received every year, the cloud operator may cover a monthly discount amount and later apply the monthly discount amount to the certificate authority 8 for settlement.

The present embodiment is described with reference to an example in which storage billing is performed. However, it is obvious that the present embodiment is applicable to not only the billing for the use of a storage but also the billing for the use of a cloud including a CPU. Additionally, the present embodiment is applicable to the update of products such as servers and other information processing equipment emitting carbon dioxide, and elevators, escalators, electric trains, automobiles, and other transportation equipment emitting carbon dioxide, which are not readily updated although products yielding a reduced amount of carbon dioxide emissions are available.

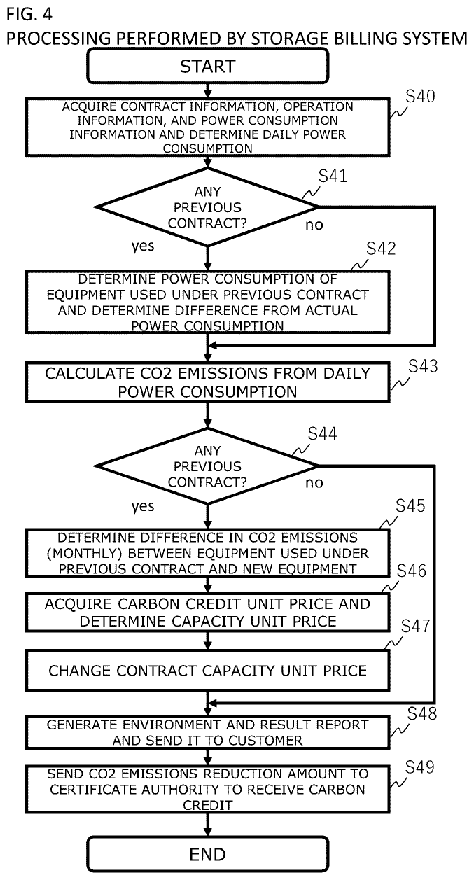

FIG. 4 is a flowchart illustrating an example of processing performed by the storage billing system according to the embodiment of the present invention. The storage billing system 2 acquires contract information from the customer contract management TBL 31, and receives operation information and power consumption information regarding the storage device from the customer site 3 (step S40). The contract history check section 24 checks the contract information to determine whether any previous contract is signed by a relevant customer.

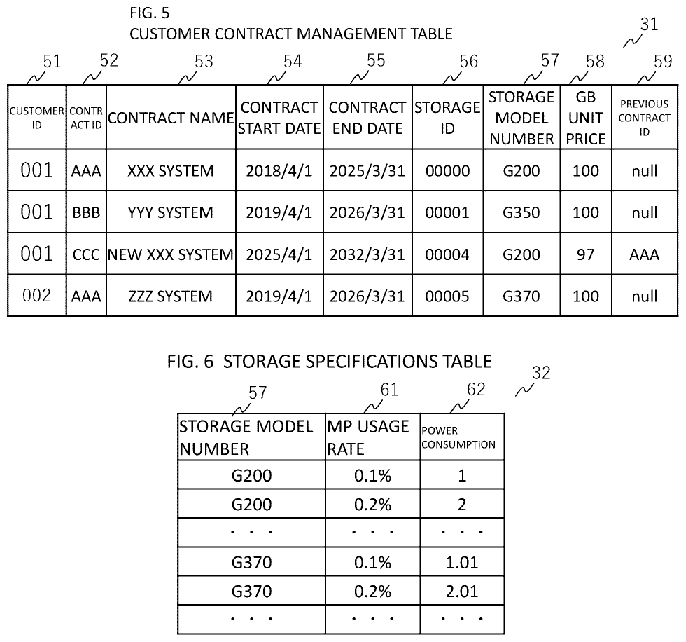

If a previous contract is signed by the customer, the power consumption difference calculation section 25 determines the power consumption of equipment used under the previous contract from a microprocessor (MP) usage rate 61, that is, the usage rate of an MP in the storage device, and then determines the difference from actual power consumption (step S42). The power consumption of the equipment used under the previous contract is determined from the storage specifications table 60 depicted in FIG. 6. In a case where the MP usage rate is not appropriate for determining the power consumption because of the difference in power saving function among various storage models, a data read/write amount, a hard disk drive's total operating time, or other numerical value may be used to determine the power consumption.

Since the amount of power usage of an air conditioner is often equivalent to that of the storage device, not only the power consumption of the storage device itself but also the amount of power usage reduction of the air conditioner used for cooling a storage device installation location may be added. In such a case, the amount of power usage reduction of the air conditioner may be determined on the assumption that the amount of power usage of the air conditioner is reduced in proportion to the amount of power usage of the storage device.

If no previous contract is signed by the customer, the storage billing system 2 skips step S42. Next, the storage billing system 2 calculates the amount of CO2 emissions from a daily power consumption (step S43).

The contract history check section 24 determines whether any previous contract is signed by the customer (step S44). If a previous contract is signed by the customer, the CO2 emissions calculation section 26 calculates the difference in the amount of CO2 emissions (monthly) between the equipment used under the previous contract and new equipment (step S45). The carbon credit calculation section 27 calculates the carbon credit from a CO2 emissions reduction amount, that is, the determined difference in the monthly amount of CO2 emissions. The fee adjustment section 28 determines a new capacity unit price from obtained carbon credit, and changes a contract capacity unit price (step S47). If it is determined that no previous contract is signed by the customer, processing returns to step S48.

If a previous contract is signed by the customer, the environment and result report generation section 30 sends, to the customer, an environment and result report that includes information regarding the CO2 emissions reduction amount and the new capacity unit price determined in steps S45 to S47 and the fee for storage usage in the current month. If no previous contract is signed by the customer, the environment and result report generation section 30 sends, to the customer, the environment and result report indicating the fee for storage usage in the current month (step S48).

In the case where a previous contract is signed by the customer, the environment and result report generation section 30 sends the information regarding the CO2 emissions reduction amount to the certificate authority 8, and receives the carbon credit.

The above example is described with reference to the CO2 emissions reduction amount of the storage device. However, the embodiment of the present invention is applicable not only to the storage device but also to a data center that additionally provides a CPU processing service. In a case where the embodiment of the present invention is applied to such a data center, it is necessary to calculate not only the power consumption according to the MP usage rate of the storage device, but also the power consumption according to a CPU usage rate.

FIG. 5 illustrates an example of the customer contract management table according to the embodiment of the present invention. The customer contract management table contains a customer ID 51, a contract ID 52, a contract name 53, a contract start date 54, a contract end date 55, a storage ID 56, a storage model number 57, a gigabyte (GB) unit price 58, and a previous contract ID 59. As for the customer ID 51, a table associated with customer names may be prepared. The same applies to the other IDs.

The previous contract ID 59 is the information describing a previous contract existing before renewal. If the contract is brand new and is still not renewed, “null” is indicated as the previous contract identification (ID) 59. It is obvious that a contract previous to a contract ID of “CCC” in the third row is “AAA” in the first row. Therefore, the GB unit price 58 is reduced from “100” to “97.”

FIG. 6 illustrates an example of the storage specifications table according to the embodiment of the present invention. The storage specifications table contains a power consumption 62 that corresponds to the MP usage rate 61 of each storage model number 57. The storage specifications table can be used to determine the power consumption of a previously used storage device from the MP usage rate 61. The example of FIG. 6 assumes that the storage specifications table contains the difference in power consumption in units of 0.1%. However, when the storage specifications table contains the power consumption in smaller units of the MP usage rate, the power consumption can be determined with higher accuracy.

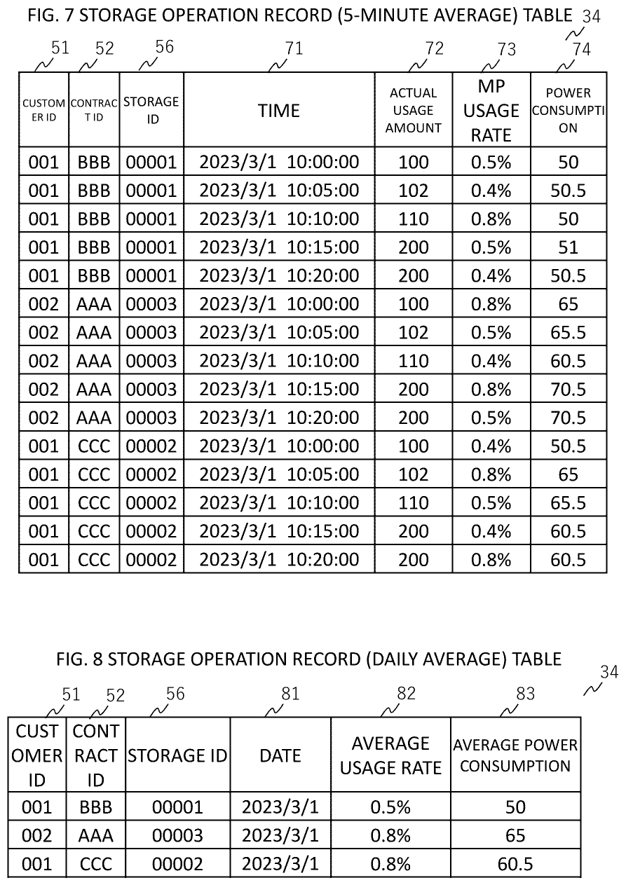

FIG. 7 illustrates an example of the storage operation record (5-minute average) table according to the embodiment of the present invention. The storage operation record (5-minute average) table contains a time 71, an actual usage amount 72, an MP usage rate 73, and a power consumption 74 in correspondence with each other at 5-minute intervals. The actual usage amount 72 represents the amount of stored data.

FIG. 8 illustrates an example of the storage operation record (daily average) table according to the embodiment of the present invention. The storage operation record (daily average) table contains daily information regarding each contract, such as a date 81, an average usage rate 82, and an average power consumption 83.

Similarly, the storage operation record table containing monthly information may be prepared.

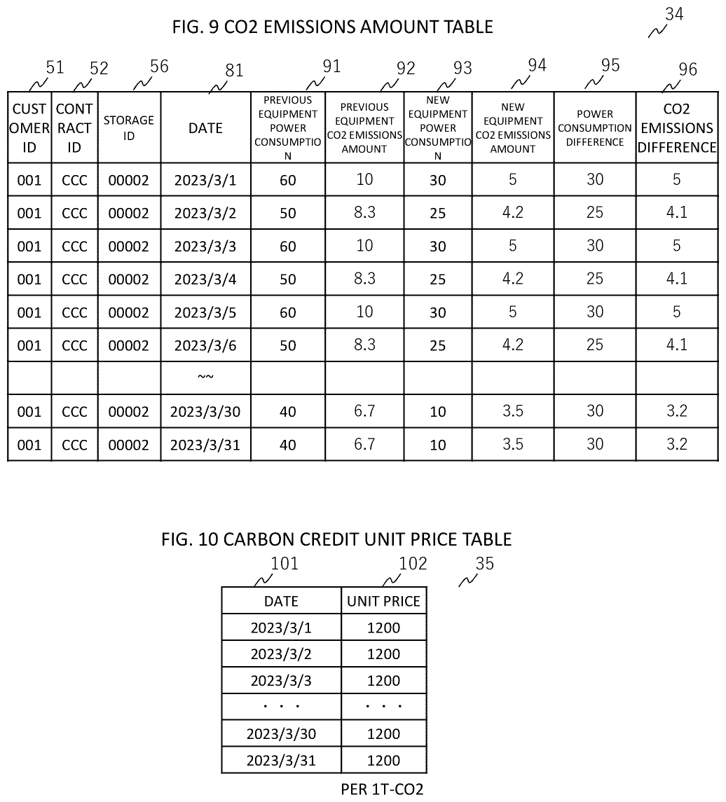

FIG. 9 illustrates an example of a CO2 emissions amount table according to the embodiment of the present invention. The CO2 emissions amount table records a previous equipment power consumption 91, a previous equipment CO2 emissions amount 92, a new equipment power consumption 93, a new equipment CO2 emissions amount 94, a power consumption difference 95, and a CO2 emissions difference 96 in correspondence with each other on the basis of a date 81. In the example of FIG. 9, the CO2 emissions amount table records daily data regarding a CCC contract.

FIG. 10 illustrates an example of the carbon credit unit price table according to the embodiment of the present invention. The carbon credit unit price table contains a unit price corresponding to 1-ton carbon dioxide reduction on a date 101. The unit price is published, for example, at a website of the certificate authority or other organization handling carbon credit transactions, and thus can be updated after referencing, for example, such a website.

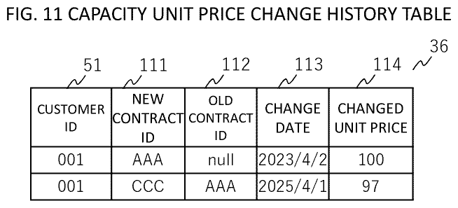

FIG. 11 illustrates an example of the capacity unit price change history table according to the embodiment of the present invention. The capacity unit price change history table contains a new contract ID 111, an old contract ID 112, a change date 113, and a changed unit price 114. In the example of FIG. 11, a contract having a new contract ID of CCC is changed to a unit price of “97.” If the contract is brand new and is still not renewed, “null” is indicated as the old contract ID 112.

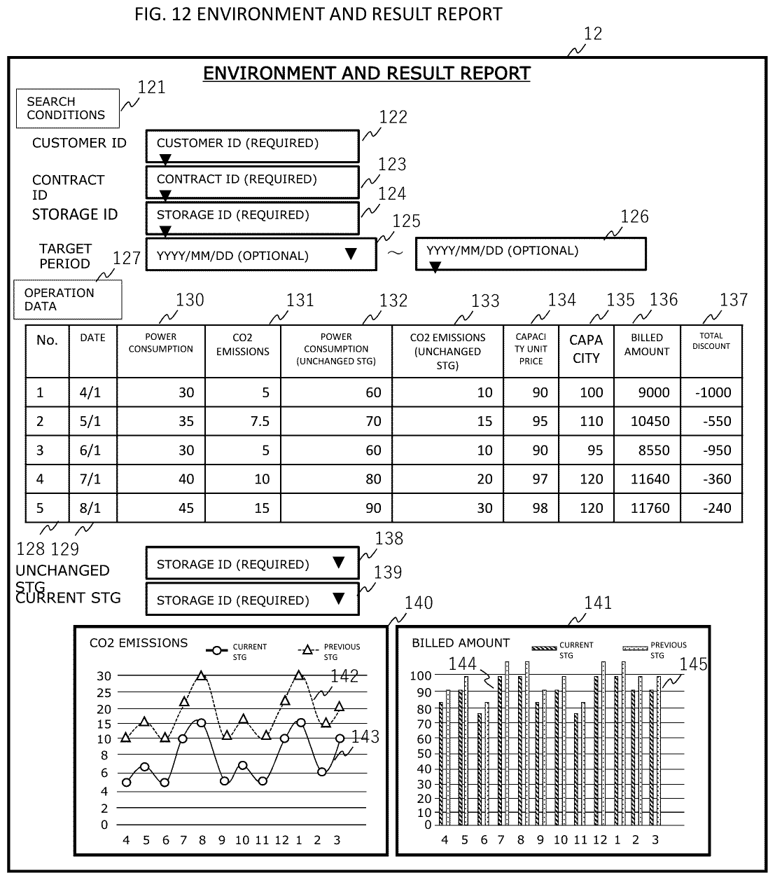

FIG. 12 illustrates an example of the environment and result report according to the embodiment of the present invention. When a customer ID 122, a contract ID 123, a storage ID 124, and target periods 125 and 126 are inputted as search conditions 121, operation data 127 appears to be displayed.

The operation data is outputted on a daily basis. The outputted operation data includes a power consumption 130, a CO2 emissions 131, a capacity unit price 134, a capacity for data storage 135, and a billed amount 136. In a case where the contract is renewed with the storage device updated, a power consumption before the update 132, a CO2 emissions 133 before the update 133, and a total discount 137 are additionally outputted as the operation data.

When an unchanged storage ID 138 and a current storage ID 139 are inputted, the CO2 emissions and billed amount of both the unchanged storage and current storage are outputted in the form of a graph.

In the example of FIG. 12, it is assumed that information is displayed on screen, for example, on a personal computer (PC) terminal. However, the information may alternatively be sent by email or conventional mail.

When the amount of carbon dioxide emissions reduction is written in the above-described report, credit can be applied for by the cloud operator while it takes time for individual storage users to apply for the credit. Therefore, the storage users receive economic benefits from carbon dioxide emissions reduction. Additionally, by indicating the amount of CO2 emissions reduction in the environment and result report, the storage users receive benefits of being capable of appealing to society by demonstrating that they are quantitatively contributing to environmental improvement.

Further, the environment and result report generation section is able to calculate, according to data actually used during a period inputted as the target period, the effect produced by receiving an input of a storage being studied as the target for an update, receiving an input of a currently used storage as the unchanged STG, and updating the currently used storage, that is, the unchanged STG 138, to a new storage, that is, the current STG 139. This also makes it possible to appeal to the storage users to recognize the effect of storage update.

What is claimed is:

1. A storage billing system for determining a fee for usage of a storage, the storage billing system comprising:
a fee calculation section that determines a fee on a basis of an amount of storage usage according to a contract that is renewed when the storage is updated;
a contract history check section that, when the fee for the usage of the storage is to be determined, determines whether the contract is renewed;
a carbon dioxide emissions calculation section that, when the contract history check section determines that the contract is renewed, determines a difference between an amount of power usage by the storage before the update and an amount of power usage by the storage after the update, and calculates an amount of carbon dioxide emissions reduction;
a fee adjustment section that determines the fee by reducing the fee determined by the fee calculation section according to the amount of carbon dioxide emissions reduction determined by the carbon dioxide emissions calculation section; and
an output section that outputs the fee determined by the fee adjustment section.

2. The storage billing system according to claim 1, wherein the fee for the usage of the storage represents an amount of data stored in the storage.

3. The storage billing system according to claim 1, further comprising:
a storage specifications table that contains information regarding each model of the storage, the information including a microprocessor usage rate and the amount of power usage before the update,
wherein the carbon dioxide emissions calculation section references the storage specifications table, and determines the amount of power usage by the storage before the update by use of the microprocessor usage rate of the current storage.

4. The storage billing system according to claim 1, wherein the output section outputs the amount of carbon dioxide emissions that corresponds to the fee.

5. The storage billing system according to claim 1, further comprising:
a report generation section that receives an unchanged storage, a changed storage, and a target period, and generates a graphical report indicating CO2 emissions and billed amount change caused by a storage change according to an amount of actual usage during the target period,
wherein the output section outputs the graphical report.

6. A storage billing method for determining a fee for usage of a storage, the storage billing method comprising the steps of:
causing a fee calculation section to determine a fee on a basis of an amount of storage usage according to a contract that is renewed when the storage is updated;
when the fee for the usage of the storage is to be determined, causing a contract history check section to determine whether the contract is renewed;
when the contract history check section determines that the contract is renewed, causing a carbon dioxide emissions calculation section to determine a difference between an amount of power usage by the storage before the update and an amount of power usage by the storage after the update, and calculate an amount of carbon dioxide emissions reduction;
causing a fee adjustment section to determine the fee by reducing the fee determined by the fee calculation section according to the amount of carbon dioxide emissions reduction determined by the carbon dioxide emissions calculation section; and
causing an output section to output the fee that is determined by the fee adjustment section.
